(19) United States
(12) Patent Application Publication
(10) Pub. No.: US 2014/0293929 A1
(43) Pub. Date: Oct. 2, 2014

(54) INFORMATION PUSHING METHOD, INFORMATION PUSHING SYSTEM AND INFORMATION TRANSMITTER

(71) Applicant: Tencent Technology (Shenzhen) Company Limited, Shenzhen City (CN)

(72) Inventors: Yuan ZHANG, Shenzhen City (CN); Shouqiang QIN, Shenzhen City (CN); Jiarun LUO, Shenzhen City (CN)

(21) Appl. No.: 14/304,751

(22) Filed: Jun. 13, 2014

Related U.S. Application Data
(63) Continuation of application No. PCT/CN2013/087953, filed on Nov. 27, 2013.

(30) Foreign Application Priority Data
Jan. 16, 2013 (CN) 201310015350.0

(51) Int. Cl. H04W 40/24

(52) U.S. Cl. CPC H04W 40/246
USPC 370/329

(57) ABSTRACT

An information pushing method, system and an information transmitter are provided, the method including: the client turning on Wi-Fi Direct function; the information transmitter turning on Wi-Fi Direct function to search for the client turning on Wi-Fi Direct function to obtain client information of the client; the information transmitter transmitting connect requesting information to a client searched; the client feeding back connect responding information to the information transmitter after receiving the connect requesting information; the information transmitter pushing information to the client feeding back the connect responding information after receiving the connect responding information. With the disclosure, even if there is no network (accessible via an access point or router) available or signal of the network is relatively poor, the information transmitter can still realize connection with a client having Wi-Fi Direct function, thereby effectively guarantee that the client acquire information pushed by the information transmitter accurately in time.

### CROSS-REFERENCE TO RELATED APPLICATIONS

This application is a U.S. continuation application of International Application PCT/CN2013/087953, with an international filing date of Nov. 27, 2013, claiming the priority benefit of Chinese Patent Application No. 201310015350.0 filed on Jan. 16, 2013, the contents of which are both incorporated by reference herein in their entireties for all intended purposes.

### TECHNICAL FIELD

The disclosure relates to information processing field, and particularly, relates to information pushing method, information pushing system and information transmitter.

### BACKGROUND

Terminal devices such as mobile phone, tablet computer, etc. have become a basic necessity of life. With prior network(s), information service provider can push various information to user(s) of mobile phone, tablet computer, etc., for example, weather information, shop information, traffic information. However, when there is no network (that needs to be accessed via an access point or a router) available or signal of the network is relatively poor at present, information pushing cannot be realized.

### SUMMARY OF THE INVENTION

This section provides a general summary of the disclosure, and is not a comprehensive disclosure of its full scope or all of its features.

One object of the embodiments of the disclosure includes providing an information pushing method in order to solve the following problem: when there is no network (that needs to be accessed via an access point or a router) available or signal of the network is relatively poor for an existing terminal device, information pushing cannot be realized.

According to one aspect of the disclosure, an information pushing method is provided that can be applied to a system including an information transmitter and at least one client, both of which have Wi-Fi Direct (Wireless Fidelity Direct) function, the method comprising:

the client turning on Wi-Fi Direct function;

the information transmitter turning on Wi-Fi Direct function to search for the client that has turned on Wi-Fi Direct function so as to obtain client information of the client;

the information transmitter transmitting connect requesting information to a client that has been searched;

the client feeding back connect responding information to the information transmitter after receiving the connect requesting information;

the information transmitter pushing information to the client that has fed back the connect responding information after receiving the connect responding information.

According to another aspect of the disclosure, an information pushing method is provided that is applied to an information transmitter that has Wi-Fi Direct function, the method comprising:

the information transmitter turning on Wi-Fi Direct function to search for a client that has turned on Wi-Fi Direct function so as to obtain client information of the client;

the information transmitter transmitting connect requesting information to a client that has been searched, and pushing information to the client that has fed back connect responding information after receiving connect responding information fed back by the client.

According to a further aspect of the disclosure, a system that pushes information is provided, the system comprising:

an information transmitter and at least one client, both of the client and the information transmitter having Wi-Fi Direct function;

the client turning on Wi-Fi Direct function, and feeding back connect responding information to the information transmitter after receiving connect requesting information transmitted by the information transmitter;

the information transmitter turning on Wi-Fi Direct function to search for the client that has turned on Wi-Fi Direct function so as to obtain client information of the client, transmitting the connect requesting information to the client that has been searched, and pushing information to the client that has fed back the connect responding information after receiving the connect responding information fed back by the client.

According to yet another aspect of the disclosure, an information transmitter is provided that has Wi-Fi Direct function, the information transmitter comprising:

a searching unit for turning on Wi-Fi Direct function to search for a client that has turned on Wi-Fi Direct function so as to obtain client information of the client;

a connect requesting unit for transmitting connect requesting information to the client that has been searched by the searching unit; and

an information pushing unit for pushing information to the client that has fed back the connect responding information after receiving connect responding information fed back by the client.

A beneficial effect of the embodiments of the disclosure includes: with the Wi-Fi Direct function of an information transmitter, even if there is no network (that needs to be accessed via an access point or a router) available or signal of the network is relatively poor, the information transmitter can still realize connection with a client having Wi-Fi Direct function, so as to effectively guarantee that the client acquire information pushed by the information transmitter accurately in time.

### BRIEF DESCRIPTION OF THE DRAWINGS

In order to describe technical solutions in the embodiments of the disclosure more clearly, accompany drawings needed in describing the embodiments or relevant arts will be introduced briefly as below. Needless to say, the accompany drawings in the following description only illustrate some embodiments of the disclosure, and according to these drawings, other drawings can be obtained without paying creative work for those ordinary skilled in the art.

FIG. 1 is a schematic diagram of a systematic scene to which the information pushing method provided by one embodiment of the disclosure is applicable;

FIG. 2 is a flow chart showing interaction in the information pushing method provided by another embodiment of the disclosure;

FIG. 3 is a flow chart showing implementation of the information pushing method provided by yet another embodiment of the disclosure; and

FIG. 4 is a block diagram showing constitution of the information transmitter provided by a further embodiment of the disclosure.

### DETAILED DESCRIPTION

To clarify the object, technical solution and advantages of the disclosure, the disclosure will be detailed with reference to accompany drawings and embodiments. As will be understood, specific embodiments are described for purpose of explaining rather than limiting the disclosure.

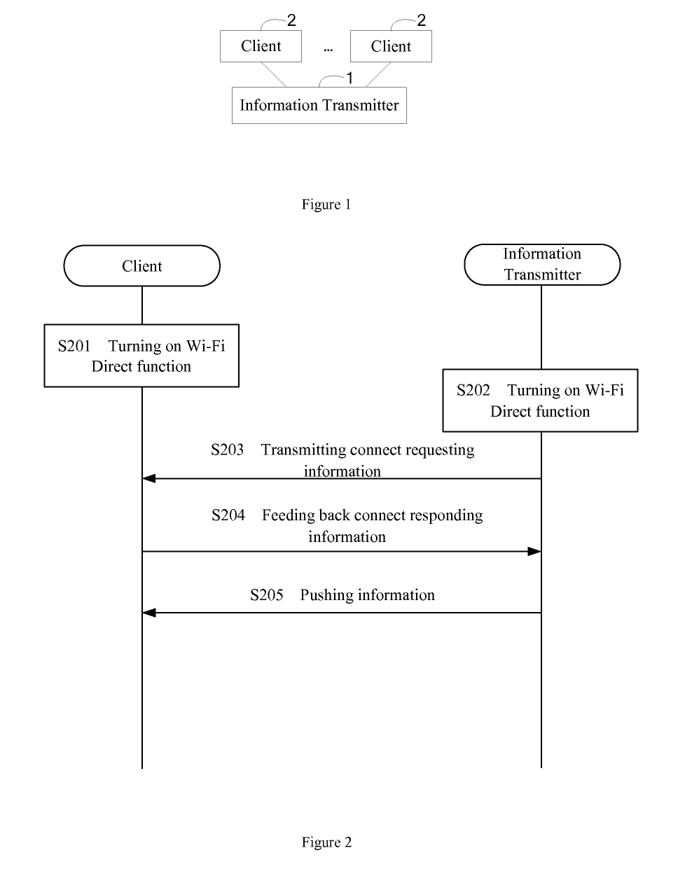

FIG. 1 illustrates a schematic diagram of a systematic scene to which the information pushing method provided by one embodiment of the disclosure is applicable. For illustrative purposes, only related parts to the present embodiment are shown.

As shown in FIG. 1, the system includes an information transmitter 1 and at least one client 2.

Both the information transmitter 1 and client 2 are terminal devices having Wireless Fidelity Direct (Wi-Fi Direct) function. The terminal devices include, but are not limited to, mobile phone, tablet computer, desktop computer, laptop computer, printer, etc.

In the present embodiment, the information transmitter 1 turns on Wi-Fi Direct function to search for client(s) 2 that has turned on Wi-Fi Direct function so as to obtain client information of the client(s), and transmits connect requesting information to the one or more clients 2 that have been searched; client(s) 2 feed back connect responding information to the information transmitter 1 after receiving the connect requesting information; the information transmitter 1 pushes information to the client(s) 2 that have fed back the connect responding information after receiving the connect responding information.

Preferably, the connect responding information carries geometric location information of the client(s) and/or the client information includes geometric location information of the client(s); after receiving the connect responding information, the information transmitter 1 pushes information related to the geometric location information, such as information on shop, hotel, restaurant, traffic etc. in the vicinity of the geometric location to the client(s) 2 that has fed back the connect responding information according to the geometric location information carried in the connect responding information or in the client information.

FIG. 2 illustrates a flow showing interaction in the information pushing method provided by another embodiment of the disclosure. The method is illustrated as below:

In step S201, the client turns on Wi-Fi Direct function.

In the present embodiment, the client is a terminal device having Wi-Fi Direct function. The client turns on Wi-Fi Direct function after receiving information instructing it to turn on Wi-Fi Direct function. The information includes instructions issued by a user to turn on Wi-Fi Direct function, or trigger information generated according to preset time interval to turn on Wi-Fi Direct function.

In step S202, the information transmitter turns on Wi-Fi Direct function to search for a client that has turned on Wi-Fi Direct function so as to obtain client information of the client.

In the present embodiment, the information transmitter is a terminal device having Wi-Fi Direct function. The information transmitter turns on Wi-Fi Direct function after receiving information instructing it to turn on Wi-Fi Direct function. The information includes instructions issued by a user to turn on Wi-Fi Direct function, or trigger information generated according to preset time interval to turn on Wi-Fi Direct function. The information transmitter that has turned on Wi-Fi Direct function can automatically search for client(s) that have turned on Wi-Fi Direct function within a certain range (about 200 meters) so as to obtain client information of the client(s). The client information includes client name, physical address or IP address and function(s) possessed by the client (for example, a printer has a printing function) and the like.

Here, Wi-Fi Direct function enables devices in a wireless network to connect to each other without access points (AP) or wireless routers, the connect mode including one-to-one and one-to-many. It is noted that the version of the software development kit (SDK) in the client and information transmitter may be 4.0 and higher.

In step S203, the information transmitter transmits connect requesting information to the client that has been searched.

In the present embodiment, the information transmitter can transmit the connect requesting information to all the clients that have been searched or to one or more clients selected by a user (from the searched clients), wherein client information of the searched clients can be displayed in a list and the like.

In step S204, the client feeds back connect responding information to the information transmitter after receiving the connect requesting information.

In the present embodiment, the client can also feed back information denying connection to the information transmitter after receiving the connect requesting information.

In step S205, the information transmitter pushes information to the client that has fed back the connect responding information after receiving the connect responding information.

Preferably, in order to make information pushing more targeted and better satisfy user's needs, in the present embodiment, the connect responding information carries geometric location information of the client(s) and/or the client information includes geometric location information of the client(s); after receiving the connect responding information, the information transmitter pushes information related to the geometric location information, such as information on shop, hotel, restaurant, traffic etc. in the vicinity of the geometric location to the client(s) that have fed back the connect responding information according to the geometric location information carried in the connect responding information or in the client information.

Here, the geometric location information of the client(s) can be obtained by means of Global Positioning System (GPS) etc.

Additionally, it is noted that in order to reduce operations of the client, in the present embodiment, both of search of terminal device(s) and connection are accomplished by the information transmitter. However, after turning on Wi-Fi Direct function, the client can also initiatively search for information transmitter(s) that has turned on Wi-Fi Direct function, transmit connect requesting information to the information transmitter(s) that has been searched, and receive information pushed by the information transmitter(s) after establishing connection.

In the present embodiment, with the Wi-Fi Direct function of the information transmitter, even if there is no network (that needs to be accessed via an access point or a router) available or signal of the network is relatively poor, the information transmitter can still realize connection with a client having Wi-Fi Direct function, so as to effectively guarantee that the client acquire information pushed by the information transmitter accurately in time. In addition, by referencing to the geometric location information of the client, information pushing can be made more targeted and better satisfy user's needs.

FIG. 3 illustrates a flow showing implementation of the information pushing method provided by yet another embodiment of the disclosure. The body performing the method is the information transmitter having Wi-Fi Direct function in the system shown in FIG. 1. The method is illustrated as below:

In step S301, the information transmitter turns on Wi-Fi Direct function to search for a client that has turned on Wi-Fi Direct function so as to obtain client information of the client.

In step S302, the information transmitter transmits connect requesting information to the client that has been searched.

In the present embodiment, the information transmitter transmits connect requesting information to the client that has been searched, and after receiving the connect requesting information, the client can select to accept or deny the connect request and feed back to the information transmitter corresponding responding information (including responding information accepting the connect request or responding information denying the connect request).

In step S303, the information transmitter pushes information to the client that has fed back the connect responding information after receiving the connect responding information fed back by the client.

Detailed implementation of each step of the present embodiment can be obtained by referencing to description of the first embodiment and therefore is omitted herein.

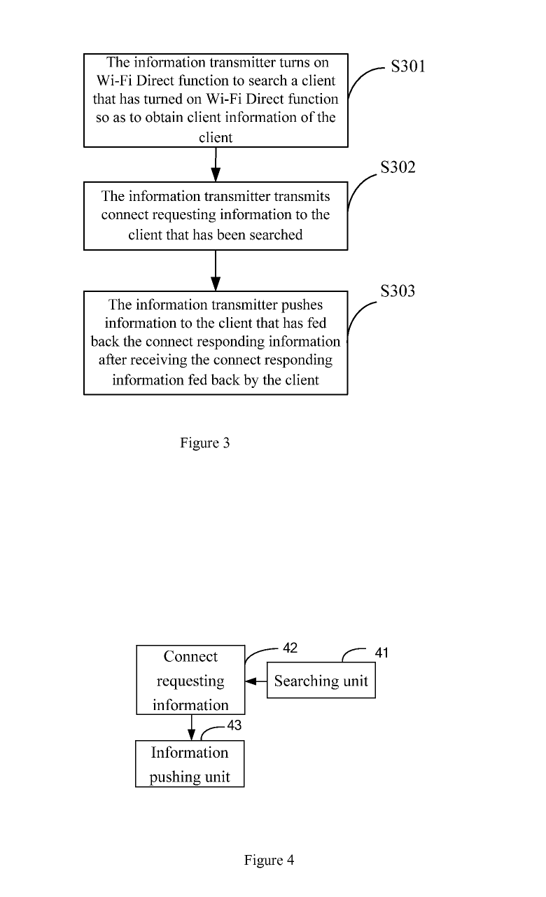

FIG. 4 illustrates constitutional structure of the information transmitter provided by a further embodiment of the disclosure. For illustrative purposes, only related parts to the present embodiment are shown.

The information transmitter is an information transmitter having Wi-Fi Direct function, and includes a searching unit 41, a connect requesting unit 42, and an information pushing unit 43, the functions of each of which are as follows:

the searching unit 41 is used for turning on Wi-Fi Direct function to search for a client that has turned on Wi-Fi Direct function so as to obtain client information of the client;

the connect requesting unit 42 is used for transmitting connect requesting information to the client that has been searched by the searching unit 41;

the information pushing unit 43 is used for pushing information to the client that has fed back the connect responding information after receiving connect responding information fed back by the client.

Further, the connect responding information carries geometric location information of the client(s); the information pushing unit 43 is used for pushing information related to the geometric location information to the client(s) that has fed back the connect responding information according to the geometric location information carried in the connect responding information after receiving the connect responding information.

Further, the client information includes geometric location information of the client(s); the information pushing unit 43 is used for pushing information related to the geometric location information to the client(s) that has fed back the connect responding information according to the geometric location information in the client information after receiving the connect responding information.

As will be understood clearly by those ordinary skilled in the art, for clarity and simplicity of description, division of the functional units mentioned above are described only for illustration. In practical applications, the above functions can be allocated to different functional units to be accomplished as necessary; that is to say, the internal structure of the information transmitter can be divided into different functional units or modules to accomplish all or part of the functions described above. The functional units in the embodiments can be integrated into one processing unit or exist separately as physical units; two or more units can be integrated into one unit, which can be implemented either by hardware or by a functional unit in software. Besides, specific names of the functional units are only for purpose of distinguishing from each other, rather than limiting the scope of protection of the application. The specific process in the units of the above apparatus can be obtained by referencing to the corresponding process in the previous method embodiment and therefore is omitted herein.

In conclusion, in the present embodiment, by means of the Wi-Fi Direct function of the information transmitter, even if there is no network (that needs to be accessed via an access point or a router) available or signal of the network is relatively poor, the information transmitter can still realize connection with a client having Wi-Fi Direct function, so as to effectively guarantee that the client acquire information pushed by the information transmitter accurately in time. In addition, by referencing to the geometric location information of the client, information pushing can be made more targeted and better satisfy user's needs.

As will also be understood by those ordinary skilled in the art, all or part of the steps in the method of the above embodiments can be accomplished by instructing relative hardware via a program, which can be stored in computer readable storing medium including ROM/RAM, magnetic disk, optical disk, and so on.

The above contents further describe the disclosure in detail with reference to specific preferred implementation, which, however, does not imply that the specific implementation of the disclosure is limited to those descriptions. For those ordinary skilled in the art, several equivalent substitutions or obvious adaptations made without departing the idea of the disclosure which have the same performance or usage should be regarded as fall within the scope of protection determined by appended claims.

What is claimed is:

1. An information pushing method, characterized in that, it is applied to a system including an information transmitter and at least one client, both of which have Wi-Fi Direct (Wireless Fidelity Direct) function, the method comprising:
the client turning on Wi-Fi Direct function;
the information transmitter turning on Wi-Fi Direct function to search for the client that has turned on Wi-Fi Direct function so as to obtain client information of the client;
the information transmitter transmitting connect requesting information to a client that has been searched;
the client feeding back connect responding information to the information transmitter after receiving the connect requesting information;
the information transmitter pushing information to the client that has fed back the connect responding information after receiving the connect responding information.

2. The method according to claim 1, characterized in that, the connect responding information carries geometric location information of the client;
the information transmitter pushing information to the client that has fed back the connect responding information after receiving the connect responding information includes:
the information transmitter pushes information related to the geometric location information to the client that has fed back the connect responding information according to the geometric location information carried in the connect responding information after receiving the connect responding information.

3. The method according to claim 1, characterized in that, the client information includes geometric location information of the client;
the information transmitter pushing information to the client that has fed back the connect responding information after receiving the connect responding information includes:
the information transmitter pushes information related to the geometric location information to the client that has fed back the connect responding information according to the geometric location information in the client information after receiving the connect responding information.

4. An information pushing method, characterized in that, it is applied to an information transmitter that has Wi-Fi Direct function, the method comprising:
the information transmitter turning on Wi-Fi Direct function to search for a client that has turned on Wi-Fi Direct function so as to obtain client information of the client;
the information transmitter transmitting connect requesting information to a client that has been searched, and pushing information to the client that has fed back connect responding information after receiving connect responding information fed back by the client.

5. The method according to claim 4, characterized in that, the connect responding information carries geometric location information of the client;
the information transmitter pushing information to the client that has fed back the connect responding information after receiving the connect responding information includes:
the information transmitter pushes information related to the geometric location information to the client that has fed back the connect responding information according to the geometric location information carried in the connect responding information after receiving the connect responding information.

6. The method according to claim 4, characterized in that, the client information includes geometric location information of the client;
the information transmitter pushing information to the client that has fed back the connect responding information after receiving the connect responding information includes:
the information transmitter pushes information related to the geometric location information to the client that has fed back the connect responding information according to the geometric location information in the client information after receiving the connect responding information.

7. A system that pushes information, characterized in that, the system comprising:
an information transmitter and at least one client, both of the client and the information transmitter having Wi-Fi Direct function;
the client turning on Wi-Fi Direct function, and feeding back connect responding information to the information transmitter after receiving connect requesting information transmitted by the information transmitter;
the information transmitter turning on Wi-Fi Direct function to search for a client that has turned on Wi-Fi Direct function so as to obtain client information of the client, transmitting the connect requesting information to the client that has been searched, and pushing information to the client that has fed back the connect responding information after receiving the connect responding information fed back by the client.

8. The system according to claim 7, characterized in that, the connect responding information carries geometric location information of the client;
the information transmitter pushing information related to the geometric location information to the client that has fed back the connect responding information according to the geometric location information carried in the connect responding information after receiving the connect responding information.

9. The system according to claim 7, characterized in that, the client information includes geometric location information of the client;
the information transmitter pushing information related to the geometric location information to the client that has fed back the connect responding information according to the geometric location information in the client information after receiving the connect responding information.

10. An information transmitter that has Wi-Fi Direct function, characterized in that, the information transmitter comprising:
a searching unit configured to turn on Wi-Fi Direct function to search for a client that has turned on Wi-Fi Direct function so as to obtain client information of the client;
a connect requesting unit for transmitting connect requesting information to the client that has been searched by the searching unit; and
an information pushing unit configured to push information to the client that has fed back the connect responding information after receiving connect responding information fed back by the client.

11. The information transmitter according to claim 10, characterized in that, the connect responding information carries geometric location information of the client;
the information pushing unit is further configured to push information related to the geometric location information to the client that has fed back the connect responding information according to the geometric location information carried in the connect responding information after receiving the connect responding information.

12. The information transmitter according to claim 10, characterized in that, the client information includes geometric location information of the client;
the information pushing unit is further configured to push information related to the geometric location information to the client that has fed back the connect responding information according to the geometric location information in the client information after receiving the connect responding information.
